(19) United States
(12) Patent Application Publication
(10) Pub. No.: US 2025/0034490 A1
(43) Pub. Date: Jan. 30, 2025

(54) BEER-FLAVORED BEVERAGE

(71) Applicant: SUNTORY HOLDINGS LIMITED, Osaka-shi, Osaka (JP)

(72) Inventor: Yuichi Kato, Fuchu-shi (JP)

(73) Assignee: SUNTORY HOLDINGS LIMITED, Osaka-shi, Osaka (JP)

(21) Appl. No.: 18/710,341

(22) PCT Filed: Nov. 30, 2022
(86) PCT No.: PCT/JP2022/044083

§ 371 Date: May 15, 2024

(30) Foreign Application Priority Data
Nov. 30, 2021 (JP) 2021-194575

(51) Int. Cl. C12C 5/02; C12C 5/04

(52) U.S. Cl. CPC C12C 5/026; C12C 5/04

(57) ABSTRACT

A beer-flavored beverage having a total nitrogen content of 25-130 mg/100 mL, a total polyphenol content of 70-210 mass ppm, and an apparent degree of fermentation of 65.0-100.0%.

### TECHNICAL FIELD

The present invention relates to a beer-taste beverage.

### BACKGROUND ART

In the related art, various beer-taste beverages have been studied and provided in response to recent diversified preferences of consumers.

For example, Patent Document 1 describes a beer-taste beverage containing 0.3 to 5 ppm of quassin and/or 0.5 to 5 ppm of quinine for the purpose of providing a beer-taste beverage having beer-like bitterness and sharp aftertaste. Under such circumstances, there is a demand for a beer-taste beverage that allows delicious taste of barley to be felt. However, a beverage that allows the delicious taste of barley to be felt has relatively strong astringency and tends to give a feeling of fullness even in a small amount.

### CITATION LIST

### Patent Document

Patent Document 1: JP 2017-6077 A

### SUMMARY OF INVENTION

### Technical Problem

There is a demand for a beer-taste beverage that does not give a feeling of fullness unsuitable for the beer-taste beverage.

### Solution to Problem

The present invention provides a beer-taste beverage having an apparent fermentation degree of 65.0 to 100.0%, in which the total nitrogen amount and the total polyphenol amount are adjusted to predetermined ranges.

That is, the present invention includes the following aspects.

[1]

A beer-taste beverage having an apparent fermentation degree of 65.0 to 100.0%, a total nitrogen amount of 25 to 130 mg/100 mL, and a total polyphenol amount of 60 to 210 mass ppm.

[2]

The beer-taste beverage according to [1], in which an original extract concentration of the beer-taste beverage is greater than or equal to 6.0 mass %.

[3]

The beer-taste beverage according to [1] or [2], in which the beer-taste beverage is a fermented beer-taste beverage.

[4]

The beer-taste beverage according to any one of [1] to [3], in which a malt proportion of the beer-taste beverage is greater than or equal to 40 mass %.

[5]

The beer-taste beverage according to any one of [1] to [4], in which the malt proportion of the beer-taste beverage is less than or equal to 80 mass %.

[6]

The beer-taste beverage according to any one of [1] to [4], having the malt proportion of 50 mass % or greater and less than 67 mass %.

[7]

The beer-taste beverage according to any one of [1] to [6], in which a content of iso-α-acid of the beer-taste beverage is from 5.0 to 40.0 mass ppm.

[8]

The beer-taste beverage according to any one of [1] to [7], in which a bitterness value of the beer-taste beverage is 10.0 to 30.0 BUs.

[9]

The beer-taste beverage according to any one of [1] to [8], in which a chromaticity of the beer-taste beverage is 5.0 to 30.0 EBC.

[10]

The beer-taste beverage according to any one of [1] to [9], in which a pH of the beer-taste beverage is 3.0 to 5.0.

[11]

A method for improving a flavor of a beer-taste beverage, the method including adjusting an apparent fermentation degree of the beer-taste beverage to 65.0 to 100.0%, a total nitrogen amount of the beer-taste beverage to 25 to 130 mg/100 mL, and a total polyphenol amount of the beer-taste beverage to 60 to 210 mass ppm.

### Advantageous Effects of Invention

According to a suitable aspect of the present invention, there is provided a beer-taste beverage which does not give an inappropriate feeling of fullness and is easy to drink in a relatively large amount. In addition, according to a suitable aspect of the present invention, there is provided a non-watery beer-taste beverage that allows the delicious taste of barley to be felt. Further, according to a suitable aspect of the present invention, there is provided a beer-taste beverage having a rich taste derived from barley.

### DESCRIPTION OF EMBODIMENTS

For numerical ranges described in the present specification, any combination of upper and lower limits is possible. For example, in a case where “preferably from 30 to 100, more preferably from 40 to 80” is described as a numerical range, a range of “from 30 to 80” and a range of “from 40 to 100” are also included in the numerical range described in the present specification. Further, for example, in a case where a numerical range is described as “preferably greater than or equal to 30, more preferably greater than or equal to 40, and preferably less than or equal to 100, more preferably less than or equal to 80”, a range of “from 30 to 80” and a range of “from 40 to 100” are also included in the numerical range described in the present specification.

Further, as a numerical range described in the present specification, for example, a description of “from 60 to 100” means a range of “greater than or equal to 60 and less than or equal to 100”.

Furthermore, in the definition of an upper limit value and a lower limit value described in the present specification, a numerical range from the lower limit value to the upper limit value can be defined by appropriately selecting limits from their options and combining them.

In addition, a plurality of various requirements described as preferred aspects described in the present specification can be combined.

### 1. Beer-Taste Beverage

In the present specification, the “beer-taste beverage” refers to an alcohol-containing carbonated beverage with a beer-like flavor. That is, unless otherwise specified, the beer-taste beverage in the present specification includes any carbonated beverage having a beer flavor.

Thus, the “beer-taste beverage” includes not only beers and fermented beer-taste beverages, which are malt-fermented beverages produced by fermenting malt, hops, and water as raw materials with yeast, but also carbonated beverages to which a beer flavoring containing an ester, a higher alcohol, lactone, or the like is added. Examples of the beer flavoring include isoamyl acetate, ethyl acetate, n-propanol, isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineol, 1,8-cineol, 2,3-diethyl-5-methylpyrazine, γ-decanolactone, γ-undecalactone, ethyl hexanoate, ethyl 2-methylbutyrate, ethyl n-butyrate, myrcene, citral, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranylacetate, ethyl butyrate, octanoic acid, decanoic acid, 9-decenoic acid, nonanoic acid, tetradecanoic acid, propanoic acid, 2-methylpropanoic acid, 7-butyrolactone, 2-aminoacetophenone, ethyl 3-phenylpropionate, 2-ethyl-4-hydroxy-5-methyl-3(2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octen-3-ol,-eudesmol, 4-mercapto-4-methylpentan-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, and phenethyl alcohol.

Furthermore, the beer-taste beverage according to an aspect of the present invention may be an ale beer-taste beverage brewed through a fermentation step using a top-fermenting yeast (such as Saccharomyces), a lager beer-taste beverage or a pilsner beer-taste beverage brewed through a fermentation step using a bottom-fermenting yeast (such as Saccharomyces), or the like. The term “fermentation” as used herein may be alcoholic fermentation in which alcohol is produced or non-alcoholic fermentation in which no alcohol is produced.

The alcohol content (ethanol content) of the beer-taste beverage is not particularly limited, but is preferably greater than or equal to 1.0 (v/v) %, more preferably greater than or equal to 2.0 (v/v) %, even more preferably greater than or equal to 3.0 (v/v) %, still even more preferably greater than or equal to 3.5 (v/v) %, and particularly preferably less than or equal to 4.0 (v/v) %, and preferably less than or equal to 10.0 (v/v) %, more preferably less than or equal to 9.0 (v/v) %, even more preferably less than or equal to 8.0 (v/v) %, still even more preferably less than or equal to 7.0 (v/v) %, and particularly preferably less than or equal to 6.5 (v/v) %, and may be less than or equal to 6.0 (v/v) %.

Note that in the present specification, the alcohol content is represented by a percentage on a volume/volume basis ((v/v) %). The alcohol content of the beverage can be measured by any known method and can be measured, for example, with a vibrating densimeter.

The alcohol content can be adjusted by appropriately setting the addition of diluting water or carbonated water, the types of raw materials (such as malt, corn grits, and sugar solution), the amounts of raw materials, the type of enzyme, the amount of enzyme added, the timing of enzyme addition, the saccharification time in a preparation tank, the protein decomposition time in the preparation tank, the pH in the preparation tank, the pH in a preparation step (wort production step from feeding of malt until before addition of yeast), the amount of the acid to be added used in the pH adjustment, the timing of the pH adjustment (such as at the time of preparation, fermentation. or completion of fermentation, before beer filtration, and after beer filtration), the set temperature and holding time in each temperature region in preparation of wort (including during saccharification), the original extract concentration in a pre-fermentation liquid, the original extract concentration in the fermentation step, the fermentation conditions (such as the oxygen concentration, aeration conditions, yeast species, amount of yeast added, the number of yeast grown, the removal timing of yeast, fermentation temperature, fermentation time, pressure setting, and carbon dioxide concentration), the addition of a spirit, a distilled alcohol or the like, and the like.

The apparent fermentation degree of the beer-taste beverage of the present invention is 65.0 to 100.0%. A beer-taste beverage having a high apparent fermentation degree can suppress a feeling of fullness, but tends to have reduced delicious taste and watery taste, thereby reducing the delicious taste of barley. Accordingly, in the beer-taste beverage of the present invention, the saccharification conditions and the fermentation conditions are adjusted in such a manner that the apparent fermentation degree of the beer-taste beverage is greater than or equal to 65.0%. In addition, the beer-taste beverage is produced to have the total nitrogen amount greater than or equal to 25 to 130 mg/100 mL and the total polyphenol amount of 60 to 210 mass ppm.

The present invention can also provide a beer-taste beverage that can be drunk in a large amount without giving an inappropriate feeling of fullness by adjusting the total nitrogen amount and the total polyphenol amount. According to a further preferred aspect, it is possible to provide a beer-taste beverage that is not watery and allows the delicious taste of barley to be felt, or a beer-taste beverage having a rich taste derived from barley.

The apparent fermentation degree of the beer-taste beverage of the present invention is greater than or equal to 65.0%, but is preferably greater than or equal to 66.0%, more preferably greater than or equal to 67.0%, even more preferably greater than or equal to 68.0%, still even more preferably greater than or equal to 69.0%, and particularly preferably greater than or equal to 70.0%, or may be greater than or equal to 72.0%, greater than or equal to 74.0%, greater than or equal to 76.0%, greater than or equal to 78.0%, greater than or equal to 80.0%, greater than or equal to 81.0%, greater than or equal to 82.0%, greater than or equal to 83.0%, greater than or equal to 84.0%, greater than or equal to 85.0%, or greater than or equal to 86.0%, from the viewpoint of producing a beer-taste beverage further improved in rich taste derived from barley.

The apparent fermentation degree of the beer-taste beverage of the present invention is less than or equal to 100.0%, but is preferably less than or equal to 99.0%, more preferably less than or equal to 98.0%, even more preferably less than or equal to 97.0%, still even more preferably less than or equal to 96.0%, and particularly preferably less than or equal to 95.0%, or may be less than or equal to 94.0%, less than or equal to 93.0%, less than or equal to 92.0%, less than or equal to 91.0%, or less than or equal to 90.0%, from the viewpoint of producing a beer-taste beverage further improved in rich taste derived from barley.

In the present specification, the “apparent fermentation degree” means the proportion of the concentration of sugar that can be consumed by yeast as a nutrient source for alcoholic fermentation to the total concentration of sugar contained in the pre-fermentation liquid. For example, the apparent fermentation degree AA of the beer-taste beverage according to the present invention can be calculated from Equation (1).

AA(%)=100×(P−Es)/P Equation (1):

In Equation (1), “P” is an original extract (original wort extract) and can be measured by the method described in “BCOJ Beer Analysis Method” (fermentation of The Brewing Society of Japan, edited by Brewers Association of Japan, revised edition of Nov. 1, 2004).

In addition, “Es” represents an apparent extract of the beer-taste beverage. The apparent extract can be calculated, for example, from Equation (2) as described in “BCOJ Beer Analysis Method” (fermentation of The Brewing Society of Japan, edited by Brewers Association of Japan, revised edition of Nov. 1, 2004).

Es=−460.234+662.649×D−202.414×D² Equation (2):

In Equation (2), D is the specific gravity of a degassed beer-taste beverage.

The apparent extract “Es” may have a negative value depending on D in Equation (2), and thus the calculated apparent fermentation degree may exceed 100%.

Note that the apparent fermentation degree of the beer-taste beverage can be adjusted by appropriately setting the addition of diluting water or carbonated water, the types of raw materials (such as malt, corn grits, and sugar solution), the amounts of raw materials, the type of enzyme, the amount of enzyme added (also including a saccharolytic enzyme or an isomerase), the temperature in enzymatic reaction, the timing of enzyme addition, the saccharification time, the pH during saccharification, the temperature during saccharification, the pH in the preparation step (wort production step from feeding of malt until before addition of yeast), the temperature in the preparation step, the time for wort filtration, the set temperature and holding time in each temperature region in preparation of wort (including during saccharification), the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), the cooling timing, the cooling temperature, the cooling time, and the like.

When the original extract (0-Ex) concentration (original wort concentration) in the beer-taste beverage is high, wateriness is less likely to be felt. Accordingly, the original extract concentration of the beer-taste beverage of an aspect of the present invention is preferably greater than or equal to 6.0 mass %, more preferably greater than or equal to 6.5 mass %, even more preferably greater than or equal to 7.0 mass %, still even more preferably greater than or equal to 7.5 mass %, and particularly preferably greater than or equal to 8.0 mass %, but may be greater than or equal to 8.2 mass %, greater than or equal to 8.5 mass %, greater than or equal to 8.6 mass %, greater than or equal to 8.7 mass %, greater than or equal to 8.8 mass %, greater than or equal to 8.9 mass %, greater than or equal to 9.0 mass %, greater than or equal to 9.1 mass %, greater than or equal to 9.2 mass %, greater than or equal to 9.3 mass %, greater than or equal to 9.4 mass %, greater than or equal to 9.5 mass %, greater than or equal to 9.6 mass %, greater than or equal to 9.7 mass %, greater than or equal to 9.8 mass %, greater than or equal to 9.9 mass %, greater than or equal to 10.0 mass %, greater than or equal to 10.1 mass %, greater than or equal to 10.2 mass %, greater than or equal to 10.3 mass %, greater than or equal to 10.4 mass %, greater than or equal to 10.5 mass %, greater than or equal to 10.6 mass %, greater than or equal to 10.7 mass %, greater than or equal to 10.8 mass %, greater than or equal to 10.9 mass %, or greater than or equal to 11.0 mass %. The original extract concentration of the beer-taste beverage of an aspect of the present invention is preferably less than or equal to 18.0 mass %, more preferably less than or equal to 17.0 mass %, even more preferably less than or equal to 16.0 mass %, still even more preferably less than or equal to 15.0 mass %, and particularly less than or equal to 14.0 mass %, but may be less than or equal to 13.8 mass %, less than or equal to 13.6 mass %, less than or equal to 13.4 mass %, less than or equal to 13.2 mass %, less than or equal to 13.0 mass %, less than or equal to 12.8 mass %, less than or equal to 12.7 mass %, less than or equal to 12.6 mass %, less than or equal to 12.5 mass %, less than or equal to 12.4 mass %, less than or equal to 12.3 mass %, less than or equal to 12.2 mass %, less than or equal to 12.1 mass %, or less than or equal to 12.0 mass %.

The original extract concentration can be adjusted by appropriately setting the addition of diluting water or carbonated water, the types of raw materials (such as malt, corn grits, and sugar solution), the amounts of raw materials, the time for wort filtration, the pH of the wort filtration, the boiling time, the boiling temperature, and the like.

The original extract (original wort extract) of the beer-taste beverage according to the present invention can be measured, for example, by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

The total nitrogen amount of the beer-taste beverage according to an aspect of the present invention is greater than or equal to 25 mg/100 mL, preferably greater than or equal to 26 mg/100 mL, more preferably greater than or equal to 27 mg/100 mL, even more preferably greater than or equal to 28 mg/100 mL, and still even more preferably greater than or equal to 29 mg/100 mL, and may be greater than or equal to 30 mg/100 mL, greater than or equal to 33 mg/100 mL, greater than or equal to 35 mg/100 mL, or greater than or equal to 38 mg/100 mL, from the viewpoint of producing a beer-taste beverage in which unsuitable wateriness is suppressed and also producing a beer-taste beverage in which a rich taste, drinking sensation, and a robust taste derived from barley are further improved.

On the other hand, when the total nitrogen amount of the beer-taste beverage is high, a feeling of fullness is likely to be given. Thus, the total nitrogen amount of the beverage according to the present invention is less than or equal to 130 mg/100 mL, preferably less than or equal to 120 mg/100 mL, more preferably less than or equal to 110 mg/100 mL, even more preferably less than or equal to 100 mg/100 mL, still even more preferably less than or equal to 90 mg/100 mL, and particularly preferably less than or equal to 80 mg/100 mL, and also may be less than or equal to 70 mg/100 mL, less than or equal to 65 mg/100 mL, or less than or equal to 60 mg/100 mL.

The “total nitrogen amount” in the present invention is the total amount of all nitrogen compounds such as proteins and amino acids.

The total nitrogen amount of the beer-taste beverage according to the present invention can be controlled by adjusting the usage amount of a raw material that has a relatively high nitrogen content and can be utilized by yeast. Specifically, the total nitrogen amount can be increased by increasing the usage amount of a raw material with a high nitrogen content, such as malt. Examples of the raw material having a high nitrogen content include malt, a soybean, a yeast extract, a pea, and an ungerminated grain. Examples of the ungerminated grain include ungerminated barley, wheat, rye, common wild oat, oat, adlay, oat, a soybean, and a pea. Other examples thereof include a corn (corn protein and the like), rice, milk raw materials such as raw milk, skim milk powder, and whey, collagen protein, collagen peptide, and a yeast extract. The total nitrogen amount can be adjusted by appropriately setting, in addition to the addition of diluting water or carbonated water and the usage amount and selection of the types of raw material, the type of enzyme, the amount of enzyme added (also including a proteolytic enzyme), the timing of enzyme addition, the protein decomposition time in a preparation tank, the pH in the preparation tank, the pH in the preparation step (wort production step from feeding of malt until before addition of yeast), the time for wort filtration, the set temperature and holding time in each temperature region in preparation of wort, the boiling time and pH in the boiling step, the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), the cooling timing, the cooling temperature, the cooling time, conditions of beer filtration (such as flow rate and temperature), the form of beer filtration (such as diatomaceous earth, membrane, sheet, cartridge, and filter), the stabilizer added at the time of beer filtration (such as silica gel, polyvinylpolypyrrolidone (PVPP), bentonite, tannin, bentonite, white clay, and acid white clay), and the like.

The total nitrogen amount of the beer-taste beverage according to the present invention can be measured, for example, by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

The total polyphenol amount of the beer-taste beverage according to an aspect of the present invention is greater than or equal to 60 mass ppm, preferably greater than or equal to 65 mass ppm, more preferably greater than or equal to 70 mass ppm, even more preferably greater than or equal to 71 mass ppm, still even more preferably greater than or equal to 72 mass ppm, yet even more preferably greater than or equal to 73 mass ppm, and may be greater than or equal to 75 mass ppm, greater than or equal to 80 mass ppm, greater than or equal to 85 mass ppm, greater than or equal to 90 mass ppm, greater than or equal to 95 mass ppm, or greater than or equal to 100 mass ppm, from the viewpoint of producing a beer-taste beverage in which unsuitable wateriness is suppressed, and a rich taste suitable for a beer-taste beverage, drinking sensation, and a robust taste are further improved.

On the other hand, when the total polyphenol amount is large, a drinking feeling becomes heavy and an inappropriate feeling of fullness is likely to be given. Accordingly, the total polyphenol amount of the beverage of the present invention is less than or equal to 210 mass ppm, preferably less than or equal to 200 mass ppm, more preferably less than or equal to 190 mass ppm, even more preferably less than or equal to 180 mass ppm, and still even more preferably less than or equal to 170 mass ppm, and may be less than or equal to 160 mass ppm, less than or equal to 150 mass ppm, less than or equal to 140 mass ppm, less than or equal to 130 mass ppm, or less than or equal to 120 mass ppm.

The polyphenol refers to a compound in which two or more hydrogen atoms of an aromatic hydrocarbon are substituted with hydroxyl groups. Examples of the polyphenol include flavonol, isoflavone, tannin, catechin, quercetin, and anthocyanin.

The “total polyphenol amount” in the present invention is the total amount of these polyphenols contained in the beer-taste beverage.

The total polyphenol amount can be adjusted by appropriately setting the addition of diluting water or carbonated water, the types of raw materials (such as malt, corn grits, and sugar solution), the amounts of raw materials, the type of enzyme, the amount of enzyme added, the timing of enzyme addition, polyphenol polymerization conditions (such as temperature and stirring speed) in a preparation tank, the pH in the preparation tank, the pH in the preparation step (wort production step from feeding of malt until before addition of yeast), the time for wort filtration, the set temperature and holding time in each temperature region in preparation of wort (including during saccharification), the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), the cooling timing, the cooling temperature, the cooling time, the form of beer filtration (such as diatomaceous earth, membrane, sheet, cartridge, and filter), the stabilizer added at the time of beer filtration (such as silica gel, polyvinylpolypyrrolidone (PVPP), bentonite, tannin, bentonite, white clay, and acid white clay), and the like.

In addition, the total polyphenol amount of the beer-taste beverage according to the present invention can be controlled by, for example, adjusting the usage amount of a raw material with a high polyphenol content, such as barley malt or malt husks (hulls). Specifically, the total polyphenol amount can be increased by increasing the usage amount of a raw material with a high polyphenol content, such as malt.

In general, malt with husks or the like has high nitrogen and polyphenol contents, and soybeans, yeast extract, peas, corn, processed corn products (such as corn grits and corn protein), wheat, wheat malt, and the like have a high nitrogen content but a low polyphenol content. Thus, the total nitrogen amount and the total polyphenol amount in the beer-taste beverage can be increased or decreased by adjusting the blending proportion of the raw materials. Hereinafter, representative methods (1) to (4) for increasing or decreasing the total nitrogen amount and the total polyphenol amount will be described.
(1) The total nitrogen amount and the total polyphenol amount of the beer-taste beverage are increased by increasing the amount of malt with husks or the like used.
(2) The total nitrogen amount of the beer-taste beverage is increased or decreased while maintaining the total polyphenol amount by increasing or decreasing the amount of soybeans, yeast extract, or the like used.
(3) The total polyphenol amount is increased while maintaining the total nitrogen amount by increasing the amount of malt with husks or the like used and decreasing the amount of soybeans, yeast extract, or the like used.
(4) The total polyphenol amount is decreased while maintaining the total nitrogen amount by decreasing the amount of malt with husks or the like used and increasing the amount of soybeans, yeast extract, or the like used.

The total polyphenol amount of the beer-taste beverage according to the present invention can be measured, for example, by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

In the beer-taste beverage of the present invention, at least some nitrogens or polyphenols are preferably derived from malt from the viewpoint of producing a beverage having a more improved taste unique to a beer-taste beverage.

In addition, in the beer-taste beverage of the present invention, at least some nitrogens or polyphenols may be derived from soybeans, yeast extract, peas, corn, a processed corn product (such as corn grits), wheat, wheat malt, or the like, from the viewpoint of producing a beverage having further an improved sobering feeling unique to a beer-taste beverage.

The beer-taste beverage according to an aspect of the present invention may further contain spirits derived from grain as an alcohol component.

In the present specification, the “spirits” means an alcoholic beverage produced by saccharifying grain, such as wheat, rice, buckwheat, corn, potato, or sugar cane, as a raw material using malt or, as necessary, an enzymatic agent, fermenting the saccharified product using yeast, and then distilling the fermented product. As the grain which is a raw material of the spirits, a plant belonging to the family Gramineae is preferable, and wheat is preferable.

The sugar concentration of the beer-taste beverage according to an aspect of the present invention is preferably less than or equal to 6.0 g/100 mL, more preferably less than or equal to 5.5 g/100 mL, more preferably less than or equal to 5.0 g/100 mL, even more preferably less than or equal to 4.8 g/100 mL, even more preferably less than or equal to 4.6 g/100 mL, still even more preferably less than or equal to 4.4 g/100 mL, still even more preferably less than or equal to 4.3 g/100 mL, and particularly preferably less than or equal to 4.2 g/100 mL, and may be less than or equal to 4.0 g/100 mL, less than or equal to 3.8 g/100 mL, less than or equal to 3.6 g/100 mL, less than or equal to 3.5 g/100 mL, less than or equal to 3.3 g/100 mL, less than or equal to 3.2 g/100 mL, or less than or equal to 3.0 g/100 mL, from the viewpoint of producing an easy-to-drink beer-taste beverage.

The sugar concentration of the beer-taste beverage according to an aspect of the present invention is preferably greater than or equal to 0.3 g/100 mL, more preferably greater than or equal to 0.5 g/100 mL, more preferably greater than or equal to 0.8 g/100 mL, even more preferably greater than or equal to 1.0 g/100 mL, even more preferably greater than or equal to 1.3 g/100 mL, still even more preferably greater than or equal to 1.5 g/100 mL, still even more preferably greater than or equal to 1.7 g/100 mL, and particularly preferably greater than or equal to 1.8 g/100 mL, and may be greater than or equal to 2.0 g/100 mL, greater than or equal to 2.2 g/100 mL, or greater than or equal to 2.5 g/100 mL, from the viewpoint of producing a beer-taste beverage with drinking sensation.

Note that the “sugar” in the present specification refers to a sugar based on the Nutrition Labeling Standards for Foods (Ministry of Health, Labour and Welfare Notification No. 176, 2003, Consumer Affairs Agency Notification No. 8, Partial Revision, Sep. 27, 2013) and specifically means a material in which protein, lipid, dietary fiber, ash, alcohol content, and water has been removed from the target food. Thus, the sugar content in a food can be calculated by subtracting the amounts of protein, lipid, dietary fiber, ash, and water from the weight of the food.

Here, the amounts of protein, lipid, dietary fiber, ash, and water can be measured by the methods described in the Nutrition Labeling Standards. Specifically, the amount of protein can be measured by a method of quantitative conversion of nitrogen, the amount of lipid can be measured by an ether extraction method, the amount of dietary fiber can be measured by the Prosky method, the amount of ash can be measured by a direct ashing method, and the amount of water can be measured by a method of heating and drying under reduced pressure.

Note that the sugar content of the beer-taste beverage according to an aspect of the present invention can be adjusted by appropriately setting the addition of diluting water or carbonated water, the type of enzyme, the amount of enzyme added, the timing of enzyme addition, the set temperature and holding time in each temperature region in preparation of the saccharified solution, the composition of the pre-fermentation liquid (such as original extract concentration, sugar composition, protein content, dietary fiber content, and ash content), various conditions of the fermentation step (such as oxygen concentration, aeration condition, yeast species, amount of yeast added, number of yeast grown, removal timing of yeast, fermentation temperature, fermentation time, pressure setting, carbon dioxide concentration, type of enzyme, amount of enzyme added, and addition timing of enzyme), cooling timing, cooling temperature, cooling time, and the like.

The chromaticity of the beer-taste beverage according to an aspect of the present invention is preferably greater than or equal to 5.0 EBC, more preferably greater than or equal to 5.3 EBC, even more preferably greater than or equal to 5.6 EBC, still even more preferably greater than or equal to 5.9 EBC, and particularly preferably greater than or equal to 6.2 EBC, and may be greater than or equal to 6.5 EBC, greater than or equal to 7.0 EBC, greater than or equal to 7.5 EBC, or greater than or equal to 8.0 EBC, from the viewpoint of producing a beer-taste beverage having a strong impact when drunk.

The chromaticity of the beer-taste beverage according to an aspect of the present invention is preferably less than or equal to 30.0 EBC, more preferably less than or equal to 27.0 EBC, even more preferably less than or equal to 25.0 EBC, still even more preferably less than or equal to 23.0 EBC, yet more preferably less than or equal to 20.0 EBC, yet even more preferably less than or equal to 18.0 EBC, and yet still even more preferably less than or equal to 16.0 EBC, and may be less than or equal to 14.0 EBC, less than or equal to 12.0 EBC, or less than or equal to 10.0 EBC.

In the present specification, the “chromaticity” of the beverage can be measured by the measurement method described in “8.8 Chromaticity” in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013). Note that the “chromaticity” of the beverage is specified by the unit of chromaticity (EBC unit) defined by the European Brewery Convention. A beverage with a smaller numerical value has a lighter and brighter color, whereas a beverage with a larger numerical value has a deeper and darker color.

In addition, the chromaticity of the beer-taste beverage according to an aspect of the present invention can be controlled, for example, by appropriately adjusting the type of malt used, the blending proportion in a case of using two or more types of malts in combination, or the boiling conditions for preparation of the pre-fermentation liquid. More specifically, for example, to increase the chromaticity of the beer-taste beverage, the chromaticity can be adjusted by increasing the blending proportion of dark malt as the malt, increasing the temperature during boiling treatment, increasing boiling time, performing decoction during preparation of a saccharified liquid, and the like. Furthermore, the chromaticity can also be adjusted to a higher level by increasing the original wort extract concentration or increasing the malt proportion. The chromaticity can also be adjusted by controlling the amount of a food additive such as caramel coloring, colored sugar solution, or the like.

The pH of the beer-taste beverage according to an aspect of the present invention is not particularly limited, but is preferably greater than or equal to 3.0, more preferably greater than or equal to 3.2, even more preferably greater than or equal to 3.4, still even more preferably greater than or equal to 3.6, and still even more preferably greater than or equal to 3.7, and may be greater than or equal to 3.9, or greater than or equal to 4.1, from the viewpoint of improving the flavor of the beverage. From the viewpoint of suppressing the generation of microorganisms, the pH of the beer-taste beverage is preferably less than or equal to 5.0, more preferably less than or equal to 4.9, even more preferably less than or equal to 4.8, still even more preferably less than or equal to 4.7, and particularly preferably less than or equal to 4.6.

The pH can be adjusted by appropriately setting the addition of diluting water or carbonated water, the types of raw materials (such as malt, corn grits, and sugar solution), the amounts of raw materials, the type of enzyme, the amount of enzyme added, the timing of enzyme addition, the saccharification time in a preparation tank, the protein decomposition time in the preparation, the pH in the preparation tank, the pH in the preparation step (wort production step from feeding of malt until before addition of yeast), the type of the acid to be added used in the pH adjustment (such as lactic acid, phosphoric acid, malic acid, tartaric acid, or citric acid), the amount of the acid to be added used in the pH adjustment, the timing of pH adjustment (at the time of preparation, fermentation, completion of fermentation, before beer filtration, after beer filtration, or the like), the set temperature and holding time in each temperature region in preparation of wort (including the time of saccharification), the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), the cooling timing, the cooling temperature, the cooling time, and the like.

The beer-taste beverage of an aspect of the present invention is suitable for an aspect of packaging. Examples of the container include a bottle, a PET bottle, a can, and a barrel. In particular, from the viewpoint of easy portability, the container is preferably a can, a bottle, or a PET bottle.

Note that in a case where a colorless transparent bottle or PET bottle is used, the beverage in the bottle is exposed to sunlight or light from a fluorescent lamp, unlike a normal can or a colored bottle. However, the beer-taste beverage according to an aspect of the present invention contains substantially no component derived from hops, whereby the occurrence of sunlight flavor due to irradiation with sunlight is suppressed. Thus, the beer-taste beverage according to an aspect of the present invention can be filled in such a colorless transparent bottle or PET bottle.

Optional additive raw materials such as grain and a sweetener that can be used for producing the beer-taste beverage according to the present invention are described in detail in “1.1 Raw materials”.

### 1.1 Raw Materials

The main raw materials of the beer-taste beverage according to an aspect of the present invention are water and malt, but hops are preferably used. In addition, a sweetener, a water-soluble dietary fiber, a bittering agent, or a bitterness imparting agent, an antioxidant, a flavoring, an acidulant, a salt, or the like may be used.

The malt refers to malt made by germinating seeds of barley or the like, such as barley, wheat, rye, common wild oat, oat, adlay, or oat, drying the germinated seeds, and removing roots, and may be from any production area and of any variety.

The malt used in an aspect of the present invention is preferably barley malt. Barley malt is one of the malts most commonly used as a raw material for Japanese beer-taste beverages. There are several types of barley, such as two-rowed barley and six-rowed barley, and any of them may be used. Furthermore, in addition to ordinary malt, colored malt or the like can also be used. When colored malt is used, different types of colored malts may be appropriately used in combination, or one colored malt may be used.

The modification of the malt used in the beer-taste beverage according to the present invention is preferably greater than or equal to 80%. When the modification is less than 80%, the viscosity of the wort increases or the turbidity thereof increases, and the production efficiency such as wort filterability or beer filterability deteriorates. Thus, it is preferable to use malt with modification of greater than or equal to 80%. In Examples and Comparative Examples, malt having a modification greater than or equal to 80% was used. The modification can be measured by the method described in 3.1.3.8 Modification and Homogeneity (Calcofluor Carlsberg Method—EBC) in MEBAK Raw Materials Barley Adjuncts Malt Hops And Hop Products Published by the Chairman Dr. Fritz Jacob Self-published by MEBAK 85350 Freising-Weihenstephan, Germany 2011.

Note that in the beer-taste beverage according to an aspect of the present invention, the malt to be used is preferably selected as appropriate in accordance with the desired chromaticity of the beer-taste beverage, and the malt to be selected may be used alone or in combination of two or more kinds thereof.

Malt contains a nitrogen compound and a polyphenol. Thus, in the present invention, it is preferable to set the proportion of malt in the raw materials within a certain range for the purpose that the total nitrogen amount and the total polyphenol amount of the beer-taste beverage according to the present invention fall within the ranges specified in the present invention. Specifically, the malt proportion (the proportion of all the malt used) is preferably greater than or equal to 40 mass %, more preferably greater than or equal to 45 mass %, even more preferably greater than or equal to 48 mass %, still even more preferably greater than or equal to 50 mass %, and particularly preferably greater than or equal to 55 mass %, and may be greater than or equal to 60 mass %, greater than or equal to 65 mass %, greater than or equal to 70 mass %, greater than or equal to 80 mass %, greater than or equal to 90 mass %, or 100 mass %. When the malt proportion is increased, it is possible to produce a beer-taste beverage which allows a rich taste derived from malt and a delicious taste of barley to be more strongly felt.

When the malt proportion is too high, a feeling of inappropriate feeling of fullness is likely to be given. Thus, the malt proportion is preferably less than or equal to 90 mass %, more preferably less than or equal to 85 mass %, even more preferably less than or equal to 80 mass %, still even more preferably less than or equal to 78 mass %, still even more preferably less than or equal to 76 mass %, still even more preferably less than or equal to 74 mass %, still even more preferably less than or equal to 72 mass %, and still even more preferably less than or equal to 70 mass %, and may be less than or equal to 68 mass %, or less than or equal to 66 mass %.

In the present specification, the “malt proportion” means a value calculated according to the Interpretation Notice on the Liquor Tax Law and the Administrative Ordinance Related to Alcoholic Beverages and the like enforced on Apr. 1, 2018.

In a case of suppressing the malt proportion, it is preferable to increase amounts of raw materials (carbon source and nitrogen source) other than malt, which can be utilized by yeast. Examples of the carbon source of the raw material that can be utilized by yeast include monosaccharides, disaccharides, trisaccharides, sugar solutions thereof, and liquid sugars containing a carbon source, and examples of the nitrogen source include yeast extract, soybean protein, malt, soybean, yeast extract, pea, wheat malt, ungerminated grains, and decomposition products thereof. Examples of the ungerminated grains include barley, wheat, rye, common wild oat, oat, adlay, oat, rice (such as white rice and brown rice), corn, kaoliang, potato, legumes (such as soybean and pea), buckwheat, sorghum, foxtail millet, and Japanese millet, which are ungerminated. In addition, starches derived from these grains and extracts thereof may be used.

The fruit, pericarp, bark, leaf, flower, stem, root, and seed of a plant other than plants of the Gramineae family such as barley, which can be used as a raw material, can be appropriately selected.

Specific examples of the plant other than plants of the Gramineae family include citrus fruits, soft fruits, herbs, and spices. Examples of the citrus fruits include an orange, Citrus junos, a lemon, a lime, a mandarin orange, a grapefruit, Citrus Iyo Group, Citrus japonica, Citrus sphaerocarpa, Citrus limetta ‘Daidai’, Citrus depressa, and Citrus sudachi.

Examples of the soft fruits include a peach, a grape, a banana, an apple, a grape, a pineapple, a strawberry, a pear, a muscat, and a blackcurrant. Examples of the herbs and the spices include coriander, pepper, fennel, Sichuan pepper, zanthoxyli fructus, cardamom, caraway, nutmeg, mace, juniper berry, allspice, vanilla, elderberry, grains of paradise, anise, and star anise.

These may be used as they are, may be used after being crushed, may be used in the form of an extract derived by extraction with an extraction solvent such as water or ethanol, or may be used after being squeezed (fruit juice or the like). One of these herbs and spices may be used alone, or two or more thereof may be used in combination.

The above can be used as appropriate in accordance with the gusto of consumers, but in order to enjoy a clear and refreshing taste like beer, it is preferable that the above citrus fruits, soft fruits, herbs, and spices are not used at all or used in a minimum amount as raw materials. In particular, a blackcurrant gives an inappropriate milky aroma in beer, and thus a blackcurrant or blackcurrant juice is preferably not used at all or used in a minimum amount.

Examples of the form of the hops used in an aspect of the present invention include pellet hops, powdered hops, and hop extract. In addition, the hops used may be a processed hop product, such as isomerized hops or reduced hops.

The amount of hops added is appropriately adjusted and is preferably from 0.0001 to 1 mass % based on the total amount of the beverage. In addition, a beer-taste beverage made using hops as a raw material is a beverage containing iso-α-acid, which is a component derived from hops. The content of iso-α-acid in the beer-taste beverage made using hops is preferably greater than or equal to 5.0 mass ppm, more preferably greater than or equal to 7.0 mass ppm, and even more preferably greater than or equal to 10.0 mass ppm, and may be greater than or equal to 13.0 mass ppm, or greater than or equal to 16.0 mass ppm, based on the total amount (100 mass %) of the beer-taste beverage. The content of iso-α-acid in the beer-taste beverage made using hops is preferably less than or equal to 40.0 mass ppm, more preferably less than or equal to 37.0 mass ppm, and even more preferably less than or equal to 34.0 mass ppm, and may be less than or equal to 30.0 mass ppm, less than or equal to 25.0 mass ppm, or less than or equal to 20.0 mass ppm, based on the total amount (100 mass %) of the beer-taste beverage.

In the present specification, the content of iso-α-acid means a value measured by the high-performance liquid chromatography (HPLC) analysis method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

The bitterness value of the beer-taste beverage according to the present invention is not particularly limited, but is preferably greater than or equal to 5.0 BUs and less than or equal to 45.0 BUs. As used herein, the term “bitterness value” refers to an index of bitterness caused by iso-α-acid such as isohumulone. The bitterness value can be measured in accordance with the method described in “BCOJ Beer Analysis Method (Revised edition on Nov. 1, 2004) 8.15 Bitterness value”. Specifically, the bitterness value (BUs) can be determined by adding an acid to a degassed sample, performing extraction with isooctane, measuring absorbance of the resulting isooctane layer at a 275 nm against isooctane, and multiplying the measured absorbance by a factor.

The bitterness value of the beer-taste beverage according to the present invention is preferably greater than or equal to 5.0 BUs, more preferably greater than or equal to 10.0 BUs, more preferably greater than or equal to 12.0 BUs, even more preferably greater than or equal to 13.0 BUs, and still even more preferably greater than or equal to 14.0 BUs.

In addition, the bitterness value of the beer-taste beverage according to the present invention is preferably less than or equal to 45.0 BUs, more preferably less than or equal to 40.0 BUs, more preferably less than or equal to 35.0 BUs, even more preferably less than or equal to 30.0 BUs, and still even more preferably less than or equal to 28.0 BUs, and may be less than or equal to 25.0 BUs, less than or equal to 23.0 BUs, less than or equal to 21.0 BUs, or less than or equal to 19.0 BUs.

The bitterness value depends on the content of iso-α-acid contained in the beverage, and iso-α-acid is a bittering component contained in hops in a large amount. Thus, a beverage having a predetermined bitterness value can be produced by controlling the amount of hops used.

Examples of the sweetener include commercially available saccharified solutions in which starch derived from grain is degraded with an acid, an enzyme, or the like, saccharides such as commercially available starch syrup, tri- or higher saccharides, sugar alcohols, isomerized sugars, natural sweeteners such as stevia, and artificial sweeteners.

These saccharides may be in the form of a liquid, such as a solution, or a solid, such as a powder.

In addition, there are no particular limitations on the type of raw material grain for starch, the method of purifying starch, and the conditions for treatment, such as hydrolysis with an enzyme or an acid. For example, a saccharide may be used with the proportion of maltose increased by appropriately setting conditions for hydrolysis with an enzyme or an acid. In addition, sucrose, fructose, glucose, maltose, trehalose, maltotriose, maltotetraose, isomaltose, isomaltotriose, isomaltotetraose, and solutions thereof (sugar solutions) can also be used.

Examples of the artificial sweetener include aspartame, acesulfame potassium (acesulfame K), and sucralose.

One of these sweeteners may be used alone, or two or more thereof may be used in combination.

Examples of the water-soluble dietary fiber include indigestible dextrin, polydextrose, guar gum degradation products, pectin, glucomannan, alginic acid, laminarin, fucoidin, and carrageenan. From the viewpoint of versatility, such as stability and safety, indigestible dextrin or polydextrose is preferred.

In the beer-taste beverage, the bitterness is preferably imparted by hops or the like, but a bittering agent or a bitterness-imparting agent may be further used.

The bittering agent or bitterness-imparting agent is not particularly limited, and a substance used as a bitterness-imparting agent in ordinary beer and low-malt beer can be used. Examples thereof include rosemary, Litchi chinensis, caraway, juniper berry, sage, rosemary, Ganoderma lucidum, bay laurel, quassin, citrus extract, bitter wood extract, coffee extract, tea extract, bitter gourd extract, lotus embryo extract, Aloe arborescens extract, rosemary extract, litchi extract, laurel extract, sage extract, caraway extract, Artemisia absinthium extract, absinthin, and alginic acid.

The antioxidant is not particularly limited, and a substance used as an antioxidant in ordinary beer and low-malt beer can be used, and examples thereof include ascorbic acid, erythorbic acid, and catechin.

The flavoring is not particularly limited, and a general beer flavoring can be used. The beer flavoring is used for imparting a beer-like flavor, and contains a brewing component generated by fermentation.

Note that the beer-taste beverage contains ethyl acetate generated by alcoholic fermentation, and the ethyl acetate functions as a flavoring. Thus, when the production process of the beer-taste beverage involves alcoholic fermentation, it is not necessary to separately add a beer flavoring, but a beer flavoring may be added as desired.

Examples of the beer flavoring other than ethyl acetate include esters and higher alcohols. Specific examples thereof include isoamyl acetate, ethyl acetate, n-propanol, isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineole, 1,8-cineole, 2,3-diethyl-5-methylpyrazine, γ-decanolactone, γ-undecalactone, ethyl hexanoate, ethyl 2-methyl butyrate, ethyl n-butyrate, myrcene, citral, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranylacetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3(2H)-furanone, dimethylsulfone, 3-methylcyclopentan-1,2-dion, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octen-3-ol, β-eudesmol, 4-mercapto-4-methylpentan-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, and phenethyl alcohol.

One of these flavorings may be used alone, or two or more of these flavorings may be used in combination.

The content of ethyl caproate in the beer-taste beverage according to the present invention is not particularly limited, but is preferably greater than or equal to 50 mass ppb and preferably less than or equal to 400 mass ppb. Ethyl caproate is known as a compound having a ginjo sake fragrance, can impart a taste having afterglow to the aftertaste of the beer-taste beverage, and can impart ease of drinking, a beer-like light throat feeling, and the like. In particular, a beer-taste beverage having an apparent fermentation degree less than or equal to 100.0% contains a relatively small amount of aromatic components, and thus, when a certain amount of ethyl caproate is contained, a rich taste suitable for the beer-taste beverage can be effectively imparted. Accordingly, the content of ethyl caproate in the beer-taste beverage according to the present invention is preferably greater than or equal to 50 mass ppb, more preferably greater than or equal to 60 mass ppb, even more preferably greater than or equal to 70 mass ppb, still even more preferably greater than or equal to 80 mass ppb, yet more preferably greater than or equal to 90 mass ppb, still yet more preferably greater than or equal to 110 mass ppb, further preferably greater than or equal to 110 mass ppb, and particularly preferably greater than or equal to 120 mass ppb.

On the other hand, to suppress a pineapple-like flavor unsuitable for a beer-taste beverage, the concentration of ethyl caproate in the beverage according to the present invention is preferably less than or equal to 800 mass ppb, more preferably less than or equal to 750 mass ppb, even more preferably less than or equal to 700 mass ppb, still even more preferably less than or equal to 650 mass ppb, still even more preferably less than or equal to 600 mass ppb, still even more preferably less than or equal to 580 mass ppb, still even more preferably less than or equal to 560 mass ppb, still even more preferably less than or equal to 540 mass ppb, still even more preferably less than or equal to 520 mass ppb, still even more preferably less than or equal to 500 mass ppb, still even more preferably less than or equal to 480 mass ppb, still even more less than or equal to preferably 460 mass ppb, still even more preferably less than or equal to 450 mass ppb, still even more preferably less than or equal to 440 mass ppb, still even more preferably less than or equal to 430 mass ppb, still even more preferably less than or equal to 420 mass ppb, still even more preferably less than or equal to 410 mass ppb, still even more preferably less than or equal to 400 mass ppb, still even more preferably less than or equal to 390 mass ppb, still even more preferably less than or equal to 380 mass ppb, still even more preferably less than or equal to 370 mass ppb, still even more preferably less than or equal to 360 mass ppb, and still even more preferably less than or equal to 350 mass ppb.

The concentration of ethyl caproate in the beer-taste beverage according to the present invention can be controlled by appropriately setting the addition of diluting water or carbonated water, the sugar composition and amino acid composition of the pre-fermentation liquid before addition of yeast, sugar concentration, amino acid concentration, original extract concentration in the pre-fermentation liquid, yeast species, fermentation conditions (such as oxygen concentration, aeration conditions, yeast species, amount of yeast added, the number of yeast grown, yeast removal timing, fermentation temperature, fermentation time, pressure setting, and carbon dioxide concentration), cooling timing, and the like. This can also be controlled by adjusting the amount of a flavoring or the like containing ethyl octanoate used.

The content of ethyl octanoate in the beer-taste beverage according to the present invention is not particularly limited, but is preferably greater than or equal to 50 mass ppb and preferably less than or equal to 800 mass ppb. Ethyl octanoate is known as a compound having a fruity aroma reminiscent of fermentation, can impart a taste having afterglow to the aftertaste of the beer-taste beverage, and can impart ease of drinking, a beer-like light throat feeling, and the like. In particular, a beer-taste beverage having an apparent fermentation degree less than or equal to 100.0% contains a relatively small amount of aromatic components, and thus, a certain content of ethyl octanoate can effectively impart a rich taste suitable for a beer-taste beverage. Accordingly, the content of ethyl octanoate in the beer-taste beverage according to the present invention is preferably greater than or equal to 50 mass ppb, more preferably greater than or equal to 60 mass ppb, even more preferably greater than or equal to 70 mass ppb, still even more preferably greater than or equal to 75 mass ppb, still even more preferably greater than or equal to 80 mass ppb, still even more preferably greater than or equal to 85 mass ppb, still even more preferably greater than or equal to 90 mass ppb, still even more preferably greater than or equal to 95 mass ppb, and still even more preferably greater than or equal to 100 mass ppb.

On the other hand, to suppress a fruit-like flavor unsuitable for a beer-taste beverage, the concentration of ethyl octanoate in the beverage according to the present invention is preferably less than or equal to 800 mass ppb, more preferably less than or equal to 700 mass ppb, even more preferably less than or equal to 600 mass ppb, still even more preferably less than or equal to 500 mass ppb, and particularly preferably less than or equal to 400 mass ppb.

The concentration of ethyl octanoate in the beer-taste beverage according to the present invention can be controlled by appropriately setting the addition of diluting water or carbonated water, the sugar composition and amino acid composition of the pre-fermentation liquid before addition of yeast, sugar concentration, amino acid concentration, original extract concentration in the pre-fermentation liquid, yeast species, fermentation conditions (such as oxygen concentration, aeration conditions, yeast species, amount of yeast added, the number of yeast grown, yeast removal timing, fermentation temperature, fermentation time, pressure setting, and carbon dioxide concentration), cooling timing, and the like. This can also be controlled by adjusting the amount of the flavoring or the like containing ethyl octanoate used.

The concentrations of ethyl caproate and ethyl octanoate in the beer-taste beverage according to the present invention can be measured, for example, by gas chromatography.

The acidulant is not particularly limited as long as it is a substance with a sour taste, and examples thereof include phosphoric acid, citric acid, gluconic acid, tartaric acid, lactic acid, malic acid, phytic acid, acetic acid, succinic acid, glucono-delta-lactone, and salts thereof.

Among these acidulants, phosphoric acid, citric acid, gluconic acid, tartaric acid, lactic acid, malic acid, phytic acid, acetic acid, succinic acid, or a salt thereof is preferable, phosphoric acid, citric acid, lactic acid, tartaric acid, acetic acid, or a salt thereof is more preferable, and phosphoric acid, lactic acid or a salt thereof is particularly preferable. One of these acidulants may be used alone, or two or more of these acidulants may be used in combination.

In the beer-taste beverage according to an aspect of the present invention, the inclusion of phosphoric acid, lactic acid, succinic acid, or a salt thereof does not particularly affect the suppression of the feeling of fullness unsuitable for the beer-taste beverage, but it is possible not to impart unsuitable sourness to the beverage while ensuring microbial assurance by lowering the pH.

Not to impart unsuitable sourness to the beer-taste beverage, the content of phosphoric acid in the beer-taste beverage according to an aspect of the present invention is preferably less than or equal to 900 mass ppm, more preferably less than or equal to 800 mass ppm, even more preferably less than or equal to 700 mass ppm, still even more preferably less than or equal to 600 mass ppm, still even more preferably less than or equal to 550 mass ppm, still even more preferably less than or equal to 500 mass ppm, still even more preferably less than or equal to 450 mass ppm, still even more preferably less than or equal to 400 mass ppm, still even more preferably less than or equal to 300 mass ppm, and particularly preferably less than or equal to 200 mass ppm.

Further, to lower the pH of the beer-taste beverage to ensure microbial assurance, the content of phosphoric acid in the beer-taste beverage according to an aspect of the present invention is preferably greater than or equal to 70 mass ppm, more preferably greater than or equal to 100 mass ppm, even more preferably greater than or equal to 120 mass ppm, still even more preferably greater than or equal to 140 mass ppm, and particularly preferably greater than or equal to 160 mass ppm.

Similarly, not to impart unsuitable sourness to the beer-taste beverage, the content of lactic acid in the beer-taste beverage according to an aspect of the present invention is preferably less than or equal to 900 mass ppm, more preferably less than or equal to 800 mass ppm, even more preferably less than or equal to 700 mass ppm, still even more preferably less than or equal to 600 mass ppm, still even more preferably less than or equal to 550 mass ppm, still even more preferably less than or equal to 500 mass ppm, still even more preferably less than or equal to 450 mass ppm, still even more preferably less than or equal to 400 mass ppm, still even more preferably less than or equal to 300 mass ppm, and particularly preferably less than or equal to 200 mass ppm.

Further, to lower the pH of the beer-taste beverage to ensure microbial assurance, the content of lactic acid in the beer-taste beverage according to an aspect of the present invention is preferably greater than or equal to 70 mass ppm, more preferably greater than or equal to 100 mass ppm, even more preferably greater than or equal to 110 mass ppm, still even more preferably greater than or equal to 130 mass ppm, and particularly preferably greater than or equal to 150 mass ppm.

Similarly, not to impart unsuitable sourness to the beer-taste beverage, in the beer-taste beverage according to an aspect of the present invention, the content of succinic acid is preferably less than or equal to 300 mass ppm, more preferably less than or equal to 250 mass ppm, even more preferably less than or equal to 200 mass ppm, still even more preferably less than or equal to 180 mass ppm, and particularly preferably less than or equal to 160 mass ppm.

Further, to lower the pH of the beer-taste beverage to ensure microbial assurance, the content of succinic acid in the beer-taste beverage according to an aspect of the present invention is preferably greater than or equal to 10 mass ppm, more preferably greater than or equal to 20 mass ppm, even more preferably greater than or equal to 30 mass ppm, still even more preferably greater than or equal to 40 mass ppm, still even more preferably greater than or equal to 45 mass ppm, and particularly preferably greater than or equal to 50 mass ppm.

The beer-taste beverage according to an aspect of the present invention preferably contains phosphoric acid, lactic acid, and succinic acid.

In the beer-taste beverage according to an aspect of the present invention, the total content of phosphoric acid, lactic acid, and succinic acid is preferably less than or equal to 1700 mass ppm, more preferably less than or equal to 1300 mass ppm, even more preferably less than or equal to 1000 mass ppm, still even more preferably less than or equal to 700 mass ppm, and particularly preferably less than or equal to 500 mass ppm from the viewpoint of imparting moderate sourness to the beer-taste beverage, and is preferably greater than or equal to 100 mass ppm, even more preferably greater than or equal to 150 mass ppm, still even more preferably greater than or equal to 200 mass ppm, and particularly preferably greater than or equal to 300 mass ppm from the viewpoint of lowering the pH of the beverage to ensure microbial assurance.

In the beer-taste beverage according to an aspect of the present invention, the content of each of phosphoric acid, lactic acid, and succinic acid and the total content thereof can be controlled, for example, by adjusting the amount of a raw material having a high content of phosphoric acid, lactic acid, or succinic acid used.

Note that the beer-taste beverage according to the present invention may contain an organic acid other than phosphoric acid, lactic acid, and succinic acid.

The content of the organic acid other than phosphoric acid, lactic acid, and succinic acid can be less than 100 parts by mass, less than 70 parts by mass, less than 50 parts by mass, less than 20 parts by mass, less than 10 parts by mass, less than 5 parts by mass, less than 1 part by mass, less than 0.1 parts by mass, or 0 parts by mass with respect to 100 parts by mass of the total amount of phosphoric acid, lactic acid, and succinic acid.

Not to impart unsuitable sourness to the beer-taste beverage, the content of pyroglutamic acid in the beer-taste beverage according to an aspect of the present invention may be less than or equal to 320 mg/L, less than or equal to 310 mg/L, less than or equal to 300 mg/L, less than or equal to 290 mg/L, less than or equal to 280 mg/L, less than or equal to 270 mg/L, less than or equal to 260 mg/L, less than or equal to 250 mg/L, less than or equal to 240 mg/L, less than or equal to 230 mg/L, less than or equal to 220 mg/L, less than or equal to 210 mg/L, less than or equal to 200 mg/L, less than or equal to 190 mg/L, less than or equal to 180 mg/L, or less than or equal to 170 mg/L. To impart a suitable taste to the beer-taste beverage, the content of pyroglutamic acid in the beer-taste beverage according to an aspect of the present invention may have greater than or equal to 58 mg/L, greater than or equal to 60 mg/L, greater than or equal to 65 mg/L, greater than or equal to 70 mg/L, greater than or equal to 75 mg/L, greater than or equal to 80 mg/L, greater than or equal to 82 mg/L, greater than or equal to 84 mg/L, greater than or equal to 86 mg/L, greater than or equal to 88 mg/L, greater than or equal to 90 mg/L, greater than or equal to 92 mg/L, greater than or equal to 94 mg/L, greater than or equal to 96 mg/L, greater than or equal to 98 mg/L, greater than or equal to 100 mg/L, greater than or equal to 102 mg/L, greater than or equal to 104 mg/L, greater than or equal to 106 mg/L, greater than or equal to 108 mg/L, or greater than or equal to 110 mg/L.

The contents of phosphoric acid and pyroglutamic acid in the beer-taste beverage of the present invention can be measured by, for example, high-performance liquid chromatography.

Examples of the preservative include benzoic acid; benzoates, such as sodium benzoate; benzoate esters, such as propyl parahydroxybenzoate and butyl parahydroxybenzoate; and dimethyl dicarbonate. In addition, for the preservative, a commercially available preparation, such as Kyohryoku Sanpurezah (Powerful Sanplezer) (a mixture of sodium benzoate and butyl benzoate, available from San-Ei Gen F.F.I., Inc.) may be used. One of these preservatives may be used alone, or two or more of these preservatives may be used in combination.

The content of the preservative is preferably 5 to 1200 mass ppm, more preferably 10 to 1100 mass ppm, even more preferably 15 to 1000 mass ppm, and still even more preferably 20 to 900 mass ppm.

Examples of the salt include sodium chloride, acid potassium phosphate, acid calcium phosphate, ammonium phosphate, magnesium sulfate, calcium sulfate, potassium metabisulfite, calcium chloride, magnesium chloride, potassium nitrate, ammonium sulfate, potassium chloride, monosodium citrate, disodium citrate, and trisodium citrate.

One of these salts may be used alone, or two or more of these salts may be used in combination.

### 1.2 Carbonic Acid Gas

As the carbonic acid gas contained in the beer-taste beverage according to an aspect of the present invention, carbonic acid gas contained in a raw material may be used, or carbonic acid gas may be dissolved by mixing with carbonated water, addition of carbonic acid gas, or the like.

The beer-taste beverage according to an aspect of the present invention is subjected to alcoholic fermentation, and thus, the carbonic acid gas generated in the fermentation step can be used as it is, but the amount of the carbonic acid gas may be adjusted by appropriately adding carbonated water.

The carbonic acid gas concentration of the beer-taste beverage according to an aspect of the present invention is preferably greater than or equal to 0.30 (w/w) %, more preferably greater than or equal to 0.35 (w/w) %, even more preferably greater than or equal to 0.40 (w/w) %, still even more preferably greater than or equal to 0.42 (w/w) %, and particularly preferably greater than or equal to 0.45 (w/w) %, and preferably less than or equal to 0.80 (w/w) %, more preferably less than or equal to 0.70 (w/w) %, even more preferably less than or equal to 0.60 (w/w) %, still even more preferably less than or equal to 0.57 (w/w), and particularly preferably less than or equal to 0.55 (w/w) %.

Note that in the present specification, the carbonic acid gas concentration can be measured by immersing a container containing a target beverage in a water bath at 20° C. for 30 minutes or longer with occasional shaking of the container to adjust the beverage to 20° C. and then using a gas volume measuring device (e.g., such as GVA-500 (available from Kyoto Electronics Manufacturing Co., Ltd.)).

In a case where the beer-taste beverage according to an aspect of the present invention is a packaged beverage, the carbonic acid gas pressure of the packaged beverage only needs to be appropriately adjusted such that the carbonic acid gas concentration is in the range described above, and is less than or equal to 5.0 kg/cm², less than or equal to 4.5 kg/cm², or less than or equal to 4.0 kg/cm², and greater than or equal to 0.20 kg/cm², greater than or equal to 0.50 kg/cm², or greater than or equal to 1.0 kg/cm². Any of these upper and lower limits may be combined. For example, the carbonic acid gas pressure of the beverage may be greater than or equal to 0.20 kg/cm² and less than or equal to 5.0 kg/cm², greater than or equal to 0.50 kg/cm² and less than or equal to 4.5 kg/cm², or greater than or equal to 1.0 kg/cm² and less than or equal to 4.0 kg/cm².

In the present specification, the gas pressure refers to the gas pressure in the container except in special cases.

The pressure can be measured by a method well-known to those skilled in the art, for example, using a method in which a sample adjusted to 20° C. is fixed to a gas internal pressure meter, the stopcock of the gas internal pressure meter is opened once to release the gas, the stopcock is closed again, the gas internal pressure meter is shaken, and a value when the pointer reaches a certain position is read; or using a commercially available gas pressure measuring device.

### 1.3 Additional Additive

To the beer-taste beverage according to an aspect of the present invention, an additive of various types may be added as necessary to the extent that the effects of the present invention are not hindered.

Examples of such an additive include colorants; foam-forming agents; fermentation promoters; yeast extract; protein-based substances, such as peptide-containing substances; and seasonings, such as amino acids.

The colorant is used to impart a beer-like color to the beverage, and a caramel dye and/or the like can be used. The foam-forming agent is used to form beer-like foam or to keep the foam of the beverage, and a plant-extracted saponin-based substance, such as soybean saponin and/or quillaja saponin; a plant protein, such as corn and/or soybean; and a peptide-containing substance, such as a collagen peptide; a yeast extract; raw materials derived from milk; and/or the like can be appropriately used.

The fermentation promoter is used to promote fermentation by yeast. For example, a yeast extract; a bran component of rice, wheat, or the like; a vitamin; a mineral agent; and/or the like can be used alone or in combination.

### 1.4 Packaged Beverage

The beer-taste beverage according to an aspect of the present invention may be a packaged beverage packaged in a container. For the packaged beverage, a container of any form and material may be used, and examples of the container include a bottle, a can, a barrel, or a PET bottle. In particular, from the viewpoint of easy portability, the container is preferably a can, a bottle, or a PET bottle.

### 2 Method for Producing Beer-Taste Beverage

A method for producing a fermented beer-taste beverage according to an aspect of the present invention includes the following steps:
(1) performing at least one treatment of saccharification treatment, boiling treatment, and solid content removal treatment on a raw material to produce a pre-fermentation liquid;
(2) cooling the pre-fermentation liquid formed in (1) to produce a cooled pre-fermentation liquid; and
(3) adding yeast to the cooled pre-fermentation liquid produced in (2) to perform alcoholic fermentation.

In the method for producing a fermented beer-taste beverage, the apparent fermentation degree, the original extract concentration, the total nitrogen amount, the total polyphenol amount, the content of pyroglutamic acid, the content of ethyl caproate, the content of ethyl octanoate, pH, and the like can be adjusted at any one or more timings of (i) to (v) below:
(i): before step (1);
(ii): simultaneously with at least one of step (1), step (2), and step (3);
(iii): between step (1) and step (2);
(iv): between step (2) and step (3); and
(v): after step (3).

The contents of pyroglutamic acid, ethyl caproate, ethyl octanoate, and the like may be adjusted by directly blending these components or by adjusting the blending amounts of raw materials containing these components. In a case where the contents of these components are too high, water or carbonated water may be added for adjustment.

### Step (1)

Step (1) is a step of performing at least one treatment of saccharification treatment, boiling treatment, and solid content removal treatment using various raw materials to produce a pre-fermentation liquid.

For example, in the case of using malt as a raw material, various raw materials including water and malt are fed in a preparation kettle or a preparation tank, and an enzymatic agent that promotes a change of a component derived from the raw material, such as a polysaccharide degrading enzyme or a proteolytic enzyme, may be added as necessary before fermentation.

Examples of the enzymatic agent include amylase, protease, purine nucleosidase, deaminase, polyphenol oxidase, glucanase, xylanase, pectinase, cellulase, lipase, glucosidase, xanthine oxidase, and transglucosidase. Examples also include enzymatic agents falling under “(3) Following Enzymatic Agents Added during Brewing Step for Purpose of Rationalization of Brewing and the like” in Article 3 “7. Articles not Handled as Raw Materials for Alcoholic Beverages” of the Notice on the Liquor Tax Law and the Administrative Ordinance Related to Alcoholic Beverages (revised on Jun. 27, 2018).

Adding these enzymatic agents can efficiently adjust the component composition of the resulting fermented beer-taste beverage. As various raw materials other than malt, hops, a preservative, a sweetener, a water-soluble dietary fiber, a bittering agent or bitterness-imparting agent, an antioxidant, a flavoring, an acidulant, a salt, and/or the like may be added. These raw materials may be added before performing the saccharification treatment, during the saccharification treatment, or after completion of the saccharification treatment. In addition, these raw materials may be added during or after the alcoholic fermentation in the next step.

A mixture of the various raw materials is heated to saccharify the starch of the raw materials to perform saccharification treatment.

The temperature and time of the saccharification treatment are preferably appropriately adjusted in view of the type of malt used, the malt proportion, raw materials other than water and malt, the type and amount of the enzyme used, the original extract concentration of the beverage finally produced, and the like. In an aspect of the present invention, from the viewpoint of adjusting the apparent fermentation degree of the beer-taste beverage in the above range, the temperature of the saccharification treatment is preferably from 55 to 75° C., and the time of the saccharification treatment is preferably from 15 to 240 minutes. After the saccharification treatment, filtration is performed, and a saccharified liquid is obtained.

The saccharified liquid is preferably subjected to boiling treatment.

When this boiling treatment is performed, hops, a bittering agent, and the like are preferably added in the case of using them as raw materials. Hops, a bittering agent, and/or the like may be added between the start of boiling the saccharified liquid and a time point before the completion of the boiling.

Instead of the saccharified liquid, a pre-fermentation liquid may be prepared by adding hops, a bittering agent, and/or the like to a mixture obtained by adding warm water to a malt extract, and boiling the mixture.

In addition, in the case without using malt, a pre-fermentation liquid may be prepared by mixing, as the raw materials, a liquid sugar containing a carbon source; a nitrogen source as an amino acid-containing raw material other than barley or malt; hops; a preservative; a sweetener; a water-soluble dietary fiber; a bittering agent or a bitterness-imparting agent; an antioxidant; a flavoring; an acidulant; a salt; and/or the like together with warm water to prepare a liquid sugar solution, and boiling the liquid sugar solution.

In the case of using hops, it may be added before the boiling treatment or may be added between the start of boiling the liquid sugar solution and before the completion of the boiling.

### Step (2)

Step (2) is a step of cooling the pre-fermentation liquid produced in step (1) to produce a cooled pre-fermentation liquid.

After the completion of the boiling treatment, the pre-fermentation liquid is transferred to a whirlpool and cooled to 0 to 23° C. After the cooling, solid contents, such as coagulated protein, may be removed to adjust the original extract concentration.

Through such treatment, a cooled pre-fermentation liquid is produced.

### Step (3)

Step (3) is a step of adding yeast to the cooled pre-fermentation liquid produced in step (2) to perform alcoholic fermentation.

The yeast used in this step can be appropriately selected in view of the type of the fermented beverage to be produced, the target flavor, the fermentation conditions, and the like, and top-fermenting yeast may be used, or bottom-fermenting yeast may be used.

The yeast in the form of a yeast suspension as is may be added to raw materials, or a slurry produced by concentrating the yeast by centrifugation or sedimentation may be added to the pre-fermentation liquid. Alternatively, a material from which the supernatant has been completely removed after the centrifugation may be added. The amount of yeast added to a stock solution can be appropriately set and is, for example, appropriately from 5×10⁶ cells/mL to 1×10⁸ cells/mL.

Various conditions, such as the fermentation temperature and the fermentation period, for performing alcoholic fermentation can be appropriately set, and fermentation may be performed, for example, under conditions of 8 to 25° C. for 5 to 10 days. During the fermentation step, the temperature (temperature increase or temperature decrease) or pressure of the fermented liquid may be changed.

The apparent fermentation degree of the beer-taste beverage can be adjusted by appropriately setting the type, amount, and timing of addition of the polysaccharide-degrading enzyme such as transglucosidase. It can be also adjusted by changing the temperature (temperature increase or temperature decrease) or pressure of the fermented liquid during the fermentation step.

In addition, after completion of this step, the yeast may be removed with a filter or the like, and water or an additive, such as a flavoring, an acidulant, or a dye, may be added as necessary.

After these steps, a step performed in the production of a beer-taste beverage known to those skilled in the art, such as a step of storing an alcoholic beverage and a filtration step, may be performed.

The fermented beer-taste beverage thus produced is filled in a predetermined container and distributed to the market as a product.

The method of packaging the fermented beer-taste beverage is not particularly limited, and a packaging method known to those skilled in the art can be used. Through the packaging step, the fermented beer-taste beverage is filled and sealed in a container. In the packaging step, a container of any form and material may be used, and examples of the container are as described above.

### 3. Method for Improving Flavor of Beer-Taste Beverage

The present invention also relates to a method for improving a flavor of a beer-taste beverage. In the method for improving a flavor according to an aspect of the present invention, specifically, the apparent fermentation degree is adjusted to 65.0 to 100.0%, the total nitrogen amount is adjusted to 25 to 130 mg/100 mL, and the total polyphenol amount is adjusted to 60 to 210 mass ppm.

In the present specification, the “flavor” of the beer-taste beverage includes a delicious taste of barley, a rich taste derived from barley, drinking sensation, and a robust taste. In addition, in the present specification, “flavor improvement” or “improving flavor” means that, in a beverage in which the apparent fermentation degree, the total nitrogen amount, and the total polyphenol amount are adjusted to the above-described ranges, at least one of reduction or suppression of unsuitable wateriness or feeling of fullness and enhancement of a rich taste suitable for a beer-taste beverage is achieved as compared with a beverage in which the adjustment is not performed.

The method for adjusting the apparent fermentation degree, the total nitrogen amount, the total polyphenol amount, and the like are as described above in “1. Beer-Taste Beverage” and “2. Method for Producing Beer-Taste Beverage”.

### Examples

Hereinafter, the present invention will be described in more detail by examples and the like, but the present invention is not limited by these examples.

In addition, in the examples, the original extract concentration, the total nitrogen amount, and the total polyphenol amount were measured by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

### Preparation of Beverage

Crushed barley malt was fed in a preparation tank containing 120 L of warm water, then the temperature was repeatedly raised and kept in a stepwise manner, and then malt dregs were removed by filtration. In addition, as shown in Tables 1 to 4, in some examples, a proteolytic enzyme was added to the warm water together with barley malt. After filtration, the raw material liquid and hops were charged into a boiling kettle, a sugar solution was added thereto to have a specified malt proportion, and the mixture was adjusted to 100 L with warm water, resulting in the formation of hot wort. Note that in Comparative Examples 2 and 5, the polysaccharide-degrading enzyme was added together with the barley malt.

The resulting hot wort was cooled and aerated with oxygen, resulting in the formation of 60 L of a pre-fermentation liquid to which yeast was still not added.

A brewer's yeast (bottom-fermenting yeast) was added to the pre-fermentation liquid thus formed, and the mixture was fermented for about one week. After a further aging period of about one week, the brewer's yeast was removed by filtration, and extract-adjusted water was added to prepare a beer-taste beverage.

In each of Examples and Comparative Examples, the amounts and types of raw materials such as malt and hops, mashing pattern, types of polysaccharide-degrading enzyme and proteolytic enzyme, addition amounts and addition timings, set temperature in each temperature region during wort preparation, retention time, pH adjustment, turbidity during wort filtration, hop addition timing, boiling time, fermentation conditions, and the like were set as appropriate to achieve the apparent fermentation degree, total nitrogen amount, total polyphenol amount, original extract concentration, sugar content, pH, and contents of pyroglutamic acid, ethyl caproate, and ethyl octanoate shown in Tables 1 to 4.

Note that in Examples 1 to 8 shown in Table 1, the pH and the contents of pyroglutamic acid, ethyl caproate, and ethyl octanoate were not adjusted and measured.

### Sensory Evaluation

Evaluation of the resulting beer-taste beverages was performed as follows by taste-testing each beverage by the same six panelists.

Each of the panelists taste-tested the beer-taste beverage cooled to about 4° C. in 350 mL, and evaluated evaluation items of “feeling of fullness unsuitable for beer-taste beverage”, “wateriness unsuitable for beer-taste beverage”, and “rich taste suitable for beer-taste beverage” with scores in increments of 0.1 in the range of 3.0 (maximum) to 1.0 (minimum) based on the following score criteria, and the average value of the scores of the six panelists was calculated. Note that in Examples 1 to 8 shown in Table 1, the evaluation item “rich taste suitable for beer-taste beverage” was not evaluated.

In the evaluation, samples that meet the following criteria “1.0”, “2.0”, and “3.0” were prepared in advance to standardize the criteria among the panelists. In addition, in the sensory evaluation of all examples and comparative examples, for the same beverage, no difference in a score value of 2.0 or more was observed among the panelists.

### Feeling of Fullness Unsuitable for Beer-Taste Beverage

“3.0”: Feeling of fullness is not perceived at all after drinking.
“2.5”: Feeling of fullness is not perceived after drinking.
“2.0”: Feeling of fullness is rarely perceived after drinking.
“1.5”: Feeling of fullness is perceived after drinking.
“1.0”: Feeling of fullness is strongly perceived after drinking.

### Wateriness Unsuitable for Beer-Taste Beverage

“3.0”: Wateriness unsuitable for a beer-taste beverage is not perceived at all.
“2.5”: Wateriness unsuitable for a beer-taste beverage is not perceived.
“2.0”: Wateriness unsuitable for a beer-taste beverage is rarely perceived.
“1.5”: Wateriness unsuitable for a beer-taste beverage is perceived.
“1.0”: Wateriness unsuitable for a beer-taste beverage is strongly perceived.

### Rich Taste Suitable for Beer-Taste Beverage

“3.0”: Rich taste typical of a beer-taste beverage is very strongly perceived.
“2.5”: Rich taste typical of a beer-taste beverage is strongly perceived.
“2.0”: Rich taste typical of a beer-taste beverage is perceived.
“1.5”: Rich taste typical of a beer-taste beverage is poorly perceived.
“1.0”: Rich taste typical of a beer-taste beverage is hardly perceived.

Based on the above three evaluation items, comprehensive evaluation was made according to the following criteria.

### Overall Evaluation

“A”: All of the average scores of the three tested sensory evaluation items are greater than or equal to 2.5.
“B”: Neither corresponding to “A” nor “C”.
“C”: Any one or more of the average scores of the three tested sensory evaluation items are less than 2.0.

### [Table 1]

TABLE 1

| | | Exam- | Exam- | Exam- | Exam- | Exam- | Exam- | Exam- | Exam- |
|---|---|---|---|---|---|---|---|---|---|
| | | ple 1 | ple 2 | ple 3 | ple 4 | ple 5 | ple 6 | ple 7 | ple 8 |
| Proportion of | mass % | 50 | 50 | 50 | 50 | 80 | 80 | 80 | 80 |
| malt used | | | | | | | | | |
| Proteolytic | | None | Added | None | Added | None | Added | None | Added |
| enzyme | | | | | | | | | |
| Original extract | mass % | 14.0 | 14.0 | 9.0 | 9.0 | 14.0 | 14.0 | 9.0 | 9.0 |
| concentration | | | | | | | | | |
| Total nitrogen | mg/100 mL | 46 | 73 | 29 | 47 | 73 | 117 | 47 | 75 |
| amount | | | | | | | | | |
| Total polyphenol | mass ppm | 117 | 120 | 75 | 77 | 187 | 191 | 120 | 123 |
| amount | | | | | | | | | |
| Apparent | % | 88 | 88 | 88 | 88 | 88 | 88 | 88 | 88 |
| fermentation | | | | | | | | | |
| degree | | | | | | | | | |

| | | | | | | | | |
|---|---|---|---|---|---|---|---|---|
| Feeling of fullness | 2.3 | 2.1 | 3.0 | 2.9 | 2.1 | 2.0 | 2.7 | 2.5 |
| unsuitable for | | | | | | | | |
| beer-taste beverage | | | | | | | | |
| Wateriness unsuitable | 2.8 | 2.9 | 2.0 | 2.1 | 3.0 | 3.0 | 2.5 | 2.4 |
| for beer-taste beverage | | | | | | | | |

### [Table 2]

TABLE 2

| | | Exam- | Exam- | Exam- | Exam- | Exam- | Exam- | Exam- | Exam- | Exam- |
|---|---|---|---|---|---|---|---|---|---|---|
| | | ple 9 | ple 10 | ple 11 | ple 12 | ple 13 | ple 14 | ple 15 | ple 16 | ple 17 |
| Proportion of | mass % | 51 | 51 | 55 | 55 | 55 | 55 | 55 | 55 | 55 |
| malt used | | | | | | | | | | |
| Proteolytic | | None | None | None | Added | None | Added | None | Added | None |
| enzyme | | | | | | | | | | |
| Original extract | mass % | 11.5 | 13.1 | 10.0 | 10.0 | 8.0 | 8.0 | 14.0 | 14.0 | 10.0 |
| concentration | | | | | | | | | | |
| Total nitrogen | mg/100 mL | 38 | 43 | 36 | 58 | 29 | 46 | 50 | 81 | 32 |
| amount | | | | | | | | | | |
| Total polyphenol | mass ppm | 98 | 111 | 92 | 94 | 73 | 75 | 128 | 132 | 92 |
| amount | | | | | | | | | | |
| Apparent | % | 88 | 88 | 88 | 88 | 88 | 88 | 88 | 88 | 70 |
| fermentation | | | | | | | | | | |
| degree | | | | | | | | | | |
| Sugar content | g/100 mL | 3.0 | 3.3 | 2.4 | 2.3 | 2.0 | 1.9 | 3.6 | 3.4 | 4.1 |
| Content of | mg/L | 90 | 105 | 85 | 84 | 81 | 65 | 165 | 166 | 100 |
| pyroglutamic acid | | | | | | | | | | |
| Content of ethyl | mass ppb | 176 | 224 | 153 | 190 | 122 | 152 | 214 | 265 | 122 |
| caproate | | | | | | | | | | |
| Content of ethyl | mass ppb | 197 | 277 | 171 | 253 | 137 | 202 | 240 | 353 | 136 |
| octanoate | | | | | | | | | | |
| pH | | 4.11 | 4.05 | 4.13 | 4.17 | 4.15 | 4.18 | 4.25 | 4.29 | 4.21 |
| Chromaticity | EBC | 8.9 | 8.9 | 8.5 | 8.4 | 7.0 | 6.8 | 13.0 | 14.2 | 8.3 |
| Bitterness value | Bus | 19.3 | 22.5 | 18.5 | 18.9 | 14.9 | 14.8 | 24.0 | 25.2 | 19.5 |
| Iso-α-acid | mass ppm | 23.9 | 24.9 | 17.6 | 21.7 | 14.2 | 17.0 | 27.6 | 29.0 | 22.4 |

| | | | | | | | | | |
|---|---|---|---|---|---|---|---|---|---|
| Feeling of fullness | 2.7 | 2.4 | 2.7 | 2.5 | 2.9 | 2.9 | 2.3 | 2.1 | 2.7 |
| unsuitable for | | | | | | | | | |
| beer-taste beverage | | | | | | | | | |
| Wateriness unsuitable | 2.7 | 2.8 | 2.7 | 2.8 | 2.2 | 2.4 | 2.9 | 3.0 | 2.7 |
| for beer-taste beverage | | | | | | | | | |
| Rich taste suitable | 2.7 | 2.9 | 2.7 | 2.8 | 2.6 | 2.5 | 2.8 | 2.9 | 2.0 |
| for beer-taste beverage | | | | | | | | | |
| Overall evaluation | A | B | A | A | B | B | B | B | B |

| | | | | | | Compar- | Compar- | Compar- |
|---|---|---|---|---|---|---|---|---|
| | | | | | | ative | ative | ative |
| | | Exam- | Exam- | Exam- | Exam- | Exam- | Exam- | Exam- |
| | | ple 18 | ple 19 | ple 20 | ple 21 | ple 1 | ple 2 | ple 3 |
| Proportion of | mass % | 55 | 55 | 55 | 55 | 55 | 55 | 55 |
| malt used | | | | | | | | |
| Proteolytic | | None | None | None | None | None | None | None |
| enzyme | | | | | | | | |
| Original extract | mass % | 10.0 | 10.0 | 10.0 | 10.0 | 5.0 | 10.0 | 10.0 |
| concentration | | | | | | | | |
| Total nitrogen | mg/100 mL | 35 | 33 | 31 | 36 | 21 | 35 | 36 |
| amount | | | | | | | | |
| Total polyphenol | mass ppm | 92 | 92 | 92 | 92 | 55 | 92 | 92 |
| amount | | | | | | | | |
| Apparent | % | 95 | 88 | 88 | 88 | 88 | 105 | 60 |
| fermentation | | | | | | | | |
| degree | | | | | | | | |
| Sugar content | g/100 mL | 1.9 | 2.4 | 2.4 | 2.4 | 1.2 | 1.1 | 4.8 |
| Content of | mg/L | 89 | 90 | 91 | 89 | 40 | 90 | 88 |
| pyroglutamic acid | | | | | | | | |
| Content of ethyl | mass ppb | 165 | 148 | 160 | 139 | 77 | 227 | 104 |
| caproate | | | | | | | | |
| Content of ethyl | mass ppb | 185 | 165 | 181 | 165 | 86 | 302 | 117 |
| octanoate | | | | | | | | |
| pH | | 4.08 | 4.49 | 3.76 | 4.33 | 4.05 | 3.99 | 4.51 |
| Chromaticity | EBC | 8.5 | 8.5 | 8.5 | 8.5 | 10.0 | 8.6 | 8.7 |
| Bitterness value | Bus | 17.5 | 22.0 | 15.0 | 21.0 | 15.0 | 16.4 | 21.0 |
| Iso-α-acid | mass ppm | 20.1 | 24.0 | 16.4 | 22.9 | 14.3 | 18.9 | 24.2 |

| | | | | | | | |
|---|---|---|---|---|---|---|---|
| Feeling of fullness | 2.7 | 2.7 | 2.7 | 2.7 | 3.0 | 2.7 | 2.7 |
| unsuitable for | | | | | | | |
| beer-taste beverage | | | | | | | |
| Wateriness unsuitable | 2.7 | 2.7 | 2.7 | 2.6 | 1.0 | 2.7 | 2.7 |
| for beer-taste beverage | | | | | | | |
| Rich taste suitable | 2.1 | 2.6 | 2.5 | 2.7 | 2.0 | 1.8 | 1.6 |
| for beer-taste beverage | | | | | | | |
| Overall evaluation | B | A | A | A | C | C | C |

### [Table 3]

TABLE 3

| | | Example | Example | Example | Example |
|---|---|---|---|---|---|
| | | 22 | 23 | 24 | 25 |
| Proportion of malt used | mass % | 59 | 66 | 66 | 66 |
| Proteolytic enzyme | | None | None | None | None |
| Original extract concentration | mass % | 11.5 | 11.5 | 13 | 10 |
| Total nitrogen amount | mg/100 mL | 44 | 39 | 55 | 39 |
| Total polyphenol amount | mass ppm | 113 | 120 | 140 | 99 |
| Apparent fermentation degree | % | 88 | 88 | 88 | 88 |
| Sugar content | g/100 mL | 3.0 | 2.9 | 3.2 | 2.2 |
| Content of pyroglutamic acid | mg/L | 115 | 160 | 180 | 110 |
| Content of ethyl caproate | mass ppb | 197 | 218 | 246 | 137 |
| Content of ethyl octanoate | mass ppb | 244 | 290 | 329 | 154 |
| pH | | 4.22 | 4.18 | 4.25 | 4.01 |
| Chromaticity | EBC | 8.9 | 8.9 | 8.9 | 8.9 |
| Bitterness value | Bus | 19.2 | 19.3 | 24 | 16.8 |
| Iso-α-acid | mass ppm | 22.9 | 23 | 27.1 | 19.9 |

| | | | | |
|---|---|---|---|---|
| Feeling of fullness unsuitable for | 2.5 | 2.7 | 2.3 | 2.7 |
| beer-taste beverage | | | | |
| Wateriness unsuitable for | 2.7 | 2.7 | 2.8 | 2.4 |
| beer-taste beverage | | | | |
| Rich taste suitable for | 2.8 | 2.7 | 2.7 | 2.6 |
| beer-taste beverage | | | | |
| Overall evaluation | A | A | B | B |

### [Table 4]

TABLE 4

| | | Exam- | Exam- | Exam- | Exam- | Exam- | Exam- | Exam- | Exam- |
|---|---|---|---|---|---|---|---|---|---|
| | | ple 26 | ple 27 | ple 28 | ple 29 | ple 30 | ple 31 | ple 32 | ple 33 |
| Proportion of | mass % | 70 | 70 | 70 | 70 | 70 | 70 | 70 | 70 |
| malt used | | | | | | | | | |
| Proteolytic | | None | Added | None | Added | None | Added | None | None |
| enzyme | | | | | | | | | |
| Original extract | mass % | 10.0 | 10.0 | 8.0 | 8.0 | 14.0 | 14.0 | 10.0 | 10.0 |
| concentration | | | | | | | | | |
| Total nitrogen | mg/100 mL | 46 | 73 | 36 | 59 | 64 | 103 | 46 | 46 |
| amount | | | | | | | | | |
| Total polyphenol | mass ppm | 117 | 120 | 93 | 96 | 163 | 168 | 117 | 117 |
| amount | | | | | | | | | |
| Apparent | % | 88 | 88 | 88 | 88 | 88 | 88 | 75 | 95 |
| fermentation | | | | | | | | | |
| degree | | | | | | | | | |
| Sugar content | g/100 mL | 2.4 | 2.3 | 1.9 | 1.8 | 3.5 | 3.3 | 3.5 | 1.9 |
| Content of | mg/L | 150 | 145 | 120 | 122 | 211 | 215 | 141 | 143 |
| pyroglutamic acid | | | | | | | | | |
| Content of ethyl | mass ppb | 153 | 190 | 122 | 152 | 214 | 265 | 130 | 205 |
| caproate | | | | | | | | | |
| Content of ethyl | mass ppb | 171 | 252 | 137 | 202 | 240 | 353 | 146 | 272 |
| octanoate | | | | | | | | | |
| pH | | 4.32 | 4.44 | 4.21 | 4.38 | 4.44 | 4.55 | 4.40 | 4.28 |
| Chromaticity | EBC | 9.0 | 8.4 | 6.2 | 6.5 | 15.1 | 15.5 | 8.3 | 8.5 |
| Bitterness value | Bus | 19.8 | 19.6 | 14.0 | 14.5 | 27.0 | 27.5 | 19.9 | 17.6 |
| Iso-α-acid | mass ppm | 22.9 | 23.3 | 13.6 | 17.3 | 32.1 | 26.7 | 22.4 | 20.4 |

| | | | | | | | | |
|---|---|---|---|---|---|---|---|---|
| Feeling of fullness | 2.6 | 2.5 | 2.8 | 2.7 | 2.2 | 2.0 | 2.7 | 2.7 |
| unsuitable for | | | | | | | | |
| beer-taste beverage | | | | | | | | |
| Wateriness unsuitable | 2.7 | 2.8 | 2.5 | 2.3 | 3.0 | 3.0 | 2.7 | 2.7 |
| for beer-taste beverage | | | | | | | | |
| Rich taste suitable | 2.8 | 2.8 | 2.7 | 2.6 | 2.8 | 2.9 | 2.2 | 2.4 |
| for beer-taste beverage | | | | | | | | |
| Overall evaluation | A | A | A | B | B | B | B | B |

| | | | | | Compar- | Compar- | Compar- | Compar- |
|---|---|---|---|---|---|---|---|---|
| | | | | | ative | ative | ative | ative |
| | | Exam- | Exam- | Exam- | Exam- | Exam- | Exam- | Exam- |
| | | ple 34 | ple 35 | ple 36 | ple 4 | ple 5 | ple 6 | ple 7 |
| Proportion of | mass % | 70 | 70 | 70 | 70 | 70 | 70 | 70 |
| malt used | | | | | | | | |
| Proteolytic | | None | None | None | None | None | None | Present |
| enzyme | | | | | | | | |
| Original extract | mass % | 10.0 | 10.0 | 10.0 | 5.0 | 10.0 | 10.0 | 18 |
| concentration | | | | | | | | |
| Total nitrogen | mg/100 mL | 45 | 43 | 46 | 23 | 46 | 46 | 135 |
| amount | | | | | | | | |
| Total polyphenol | mass ppm | 117 | 117 | 117 | 58 | 117 | 117 | 221 |
| amount | | | | | | | | |
| Apparent | % | 88 | 88 | 88 | 88 | 105 | 60 | 88 |
| fermentation | | | | | | | | |
| degree | | | | | | | | |
| Sugar content | g/100 mL | 2.4 | 2.4 | 2.4 | 1.2 | 1.1 | 4.8 | 4.3 |
| Content of | mg/L | 145 | 145 | 145 | 55 | 144 | 141 | 320 |
| pyroglutamic acid | | | | | | | | |
| Content of ethyl | mass ppb | 165 | 150 | 167 | 79 | 226 | 104 | 351 |
| caproate | | | | | | | | |
| Content of ethyl | mass ppb | 192 | 170 | 177 | 89 | 301 | 117 | 455 |
| octanoate | | | | | | | | |
| pH | | 4.46 | 3.94 | 4.53 | 4.11 | 4.09 | 4.54 | 4.59 |
| Chromaticity | EBC | 8.5 | 8.5 | 8.5 | 8.9 | 8.6 | 8.7 | 21 |
| Bitterness value | Bus | 21.0 | 14.8 | 21.1 | 19.0 | 16.3 | 21.2 | 31 |
| Iso-α-acid | mass ppm | 23.9 | 16.2 | 22.8 | 21.9 | 18.8 | 24.4 | 35 |

| | | | | | | | |
|---|---|---|---|---|---|---|---|
| Feeling of fullness | 2.5 | 2.7 | 2.7 | 2.8 | 2.7 | 2.7 | 1.2 |
| unsuitable for | | | | | | | |
| beer-taste beverage | | | | | | | |
| Wateriness unsuitable | 2.7 | 2.7 | 2.7 | 1.2 | 2.7 | 2.7 | 3.0 |
| for beer-taste beverage | | | | | | | |
| Rich taste suitable | 2.4 | 2.9 | 2.7 | 2.1 | 1.9 | 1.7 | 3.0 |
| for beer-taste beverage | | | | | | | |
| Overall evaluation | B | A | A | C | C | C | C |

From the results of Examples, when the total nitrogen amount in the beer-taste beverage was 25 to 130 mg/100 mL, the total polyphenol amount was 60 to 210 mass ppm, and the apparent fermentation degree was 65.0 to 100.0%, it was possible to provide a beverage having “rich taste suitable for a beer-taste beverage” while suppressing “feeling of fullness unsuitable for a beer-taste beverage” and suppressing “wateriness unsuitable for a beer-taste beverage”.

1. A beer-taste beverage having an apparent fermentation degree of 65.0 to 100.0%, a total nitrogen amount of 25 to 130 mg/100 mL, and a total polyphenol amount of 60 to 210 mass ppm.

2. The beer-taste beverage according to claim 1, wherein an original extract concentration of the beer-taste beverage is greater than or equal to 6.0 mass %.

3. The beer-taste beverage according to claim 1, wherein the beer-taste beverage is a fermented beer-taste beverage.

4. The beer-taste beverage according to claim 1, wherein a malt proportion of the beer-taste beverage is greater than or equal to 40 mass %.

5. The beer-taste beverage according to claim 1, wherein the malt proportion of the beer-taste beverage is less than or equal to 80 mass %.

6. The beer-taste beverage according to claim 1, wherein the malt proportion of the beer-taste beverage is greater than or equal to 50 mass % and less than 67 mass %.

7. The beer-taste beverage according to claim 1, wherein a content of iso-α-acid of the beer-taste beverage is 5.0 to 40.0 mass ppm.

8. The beer-taste beverage according to claim 1, wherein a bitterness value of the beer-taste beverage is 10.0 to 30.0 BUs.

9. The beer-taste beverage according to claim 1, wherein a chromaticity of the beer-taste beverage is 5.0 to 30.0 EBC.

10. The beer-taste beverage according to claim 1, wherein a pH of the beer-taste beverage is 3.0 to 5.0.

11. A method for improving a flavor of a beer-taste beverage, the method including adjusting an apparent fermentation degree of the beer-taste beverage to 65.0 to 100.0%, a total nitrogen amount of the beer-taste beverage to 25 to 130 mg/100 mL, and a total polyphenol amount of the beer-taste beverage to 60 to 210 mass ppm.
